(19) United States
(12) Patent Application Publication
(10) Pub. No.: US 2007/0153847 A1
(43) Pub. Date: Jul. 5, 2007

(54) Manufacturing and the design of assemblies for high power laser diode array modules

(75) Inventors: Brian Faircloth, Ballwin, MO (US); Mike Gall, St. Charles, MO (US); Wayne Penn, St. Peters, MO (US); Mark Zediker, St. Charles, MO (US)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: NUVONYX, INC, Bridgeton, MO (US)

(21) Appl. No.: 11/641,661

(22) Filed: Dec. 20, 2006

Related U.S. Application Data
(60) Provisional application No. 60/752,056, filed on Dec. 21, 2005.

(51) Int. Cl. H01S 3/04

(52) U.S. Cl. 372/35

(57) ABSTRACT

A method (and structure) of manufacturing high power laser diode array modules provides multi kilowatts of power for a semiconductor-based laser. The method also provides an array module having lower flow requirements. The array module provides a controlled, closed environment for the arrays to operate within, as well as a back reflection shield behind the arrays, which yields protection between the array and the array module housing. The structure may include two different array module configurations, the first being one stackable array of one hundred and fifty laser diode bar packages, which includes a high-flow, low-pressure drop heatsink providing a large plenum size for the array, reducing turbulent flow and lowering the required pressure for the array. The second configuration is a multi-stringed array configuration, providing multi kilowatts of power within a shoebox-sized footprint, incorporating the high-flow, low-pressure drop end caps, providing smaller flow restrictions.

### BACKGROUND OF THE INVENTION

1. Field of the Invention

The present invention generally relates to a method and apparatus for diode lasers, and more particularly to a method and apparatus for manufacturing high power direct diode laser arrays for use in systems and specific pump applications. The laser diodes may be packaged in a configuration to provide a continuous wave of operation [CW] for applications such as, but not limited to, material processing. In doing so, the design of the array and the array enclosure or array module is important due to the nature of the activity and involvement with the surrounding laser industry.

2. Description of the Related Art

The development of the semiconductor laser is based on the amplification in a diode bar considering the forward biases of the GaAs p-n junction of the device to emit photons. Certain aspects of the present invention are directed to development and designs that provide an ability to manufacture high power direct diode laser arrays in excess of tens upon tens of kilowatts of optical power.

Moreover, conventional designs in the laser diode stack industry have an upper limit of 30 laser diode packages, due to flow and manufacturability. This array stack configuration is designed to not allow for lateral displacement with respect to the bar.

### SUMMARY OF THE INVENTION

In view of the foregoing and other exemplary problems, drawbacks, and disadvantages of the conventional methods and structures, an exemplary feature of the present invention is to provide a method and structure in which to manufacture laser diode arrays. These arrays exhibit unique characteristics such as the ability to stack packages in a two-dimensional configuration, wherein the packages may include a heatsink, laser diode bar, an insulator and a lid. In addition, the inventors have demonstrated in these arrays the ability to enclose the arrays in a pluggable atmosphere for ideal operating conditions, as well as protection for the array.

In accordance with a first exemplary aspect of the present invention, a method of manufacturing high power laser diode arrays includes stacking laser diode packages in one array.

In accordance with a second exemplary aspect of the present invention, a method of manufacturing a heatsink that provides the ability to build high power laser arrays includes using gaskets in two-dimensional array packages, and configuring a water flow that allows the heat to be dissipated in a two-dimensional stack, the configuring of the water is based on at least one of directional characteristics, physical properties and fluid routing for relief of pressure restrictions.

In accordance with a third exemplary aspect of the present invention, a high power laser array includes an end cap that allows a smooth transition for fluid flow, wherein the end cap provides characteristics for fluid flow requirements regarding the pressure drop of the array.

In accordance with a fourth exemplary aspect of the present invention, a high power diode array module includes a housing assembly including a reflective or abortive water-cooled front, an anti-reflective window disposed behind arrays of the array module, and a purge and temperature humidity sensor. The arrays of the array module are enclosed in a controlled environment for high power laser applications.

In accordance with a fifth exemplary aspect of the present invention, a heatsink includes a water flow configured to allow heat to be dissipated in a two-dimensional stack.

In accordance with a sixth exemplary aspect of the present invention, a laser diode array includes at least one laser diode bar, the laser diode bar including a water flow configured to allow heat to be dissipated in a two-dimensional stack.

In accordance with a seventh exemplary aspect of the present invention, a laser diode array module includes at least one laser diode bar, the laser diode bar including a water flow configured to allow heat to be dissipated in a two-dimensional stack.

An exemplary aspect of the present invention provides an ability to precisely manufacture a diode laser array module in unique configurations. According to certain exemplary aspects of the present invention, a one hundred and fifty bar array may be manufactured, in a single two-dimensional array, with an emitting power of 12,000 Watts. 12,000 Watts is the test upper limit of the design of the claimed invention. Very high power solid state laser systems (i.e., some military lasers) require highly specialized diode laser pump sources such as the one described. These pumps can consist of very large stacks of diode laser bars.

As stated previously, conventional systems are incapable of providing the size stacks (in length and power) to supply this need. Additionally, industrial laser systems are in an upward trend in power, also requiring even larger stacks. Industrial laser systems will reach a point where conventional diode laser packaging methods will no longer be adequate.

Another exemplary aspect of the present invention is directed to the ability to design and manufacture custom arrays modules with an optical power of 45,000 Watts. Accordingly, other features of the array module may include a purge and temperature humidity sensor for creating ideal operation conditions. The array module may also include a water-cooled front nose and a unique heat reflector behind the individual arrays inside the array module.

The inventors have designed, modeled, tested and manufactured unique array end caps. These end caps are placed on the top and bottom of an array in order to route fluid flow through the array. The novelty and advantage in the laser industry of this design is the ability to provide high fluid flow at a low pressure loss through the array end cap and the array module.

Additionally, to accommodate flow requirements for specific applications, the inventors have developed a high flow, low pressure drop heatsink for the diode bar to be mounted on. By doing so, the heatsink provides an increased plenum size advantage for cooling the array that is essential in the laser diode market for large diode arrays.

The design of the heat sink is such that the mechanical structure of a diode laser can be realized internal to the package (i.e., the support rods pass through holes in the heat sink), thus eliminating the need for an external exo-skeleton structure.

### BRIEF DESCRIPTION OF THE DRAWINGS

The foregoing and other exemplary purposes, aspects and advantages will be better understood from the following detailed description of an exemplary embodiment of the invention with reference to the drawings, in which:

FIG. 1A depicts an isometric view of a 12 kW laser diode array according to an exemplary embodiment of the present invention;

FIG. 1B depicts a side assembly view of the 12 kW laser diode array depicted in FIG. 1A;

FIG. 1C depicts an actual view of a 12 kW laser diode array module according to an exemplary embodiment of the present invention;

FIG. 2A depicts a front view of a 24 kW laser diode array module according to an exemplary embodiment of the present invention;

FIG. 2B depicts a back view of the 24 kW laser diode array module depicted in FIG. 2A;

FIG. 2C depicts a front view of a 45 kW laser diode array module according to an exemplary embodiment of the present invention;

FIG. 2D depicts a back view of the 45 kW laser diode array module depicted in FIG. 2C;

FIG. 3A depicts a conventional array end cap design according to an exemplary embodiment of the present invention;

FIG. 3B depicts a high-flow, low-pressure drop array end cap design according to an-exemplary embodiment of the present invention;

FIG. 3C depicts an actual view of the high-flow, low-pressure drop array end cap design depicted in FIG. 3B;

FIG. 4A depicts a side view of a high-flow, low-pressure drop heat sink according to an exemplary embodiment of the present invention;

FIG. 4B illustrates an isometric view of the high-flow, low-pressure drop heat sink depicted in FIG. 4A;

FIG. 4C illustrates an exploded view of the high-flow, low-pressure drop heat sink depicted in FIG. 4A; and

FIG. 4D depicts interchangeable layers of the high-flow, low-pressure drop heat sink depicted in FIG. 4A.

### DETAILED DESCRIPTION OF EXEMPLARY EMBODIMENTS OF THE INVENTION

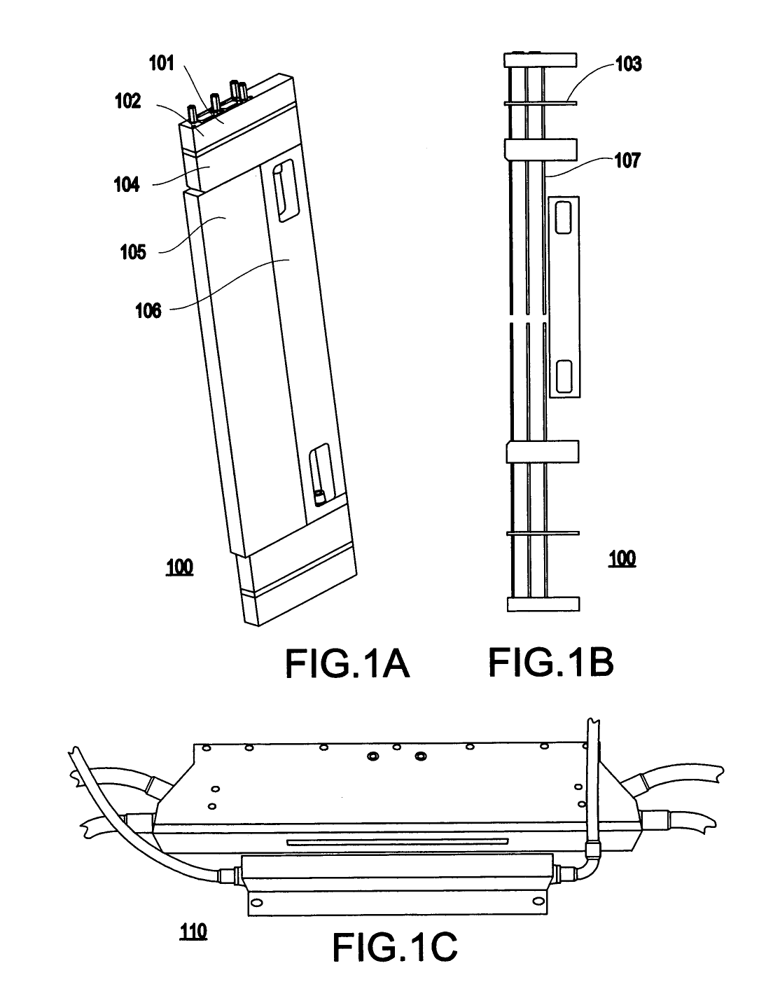

Referring now to the drawings, and more particularly to FIGS. 1A-4D, there are shown exemplary embodiments of the method and structures according to the present invention.

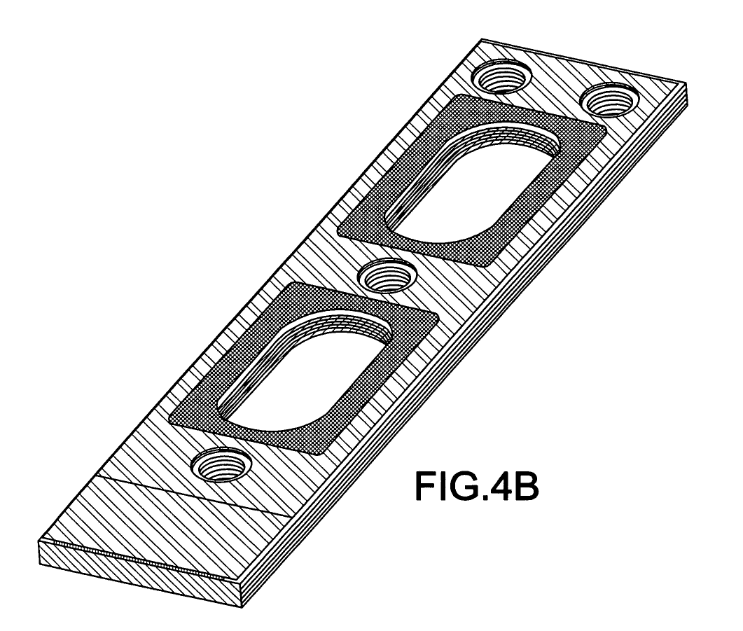

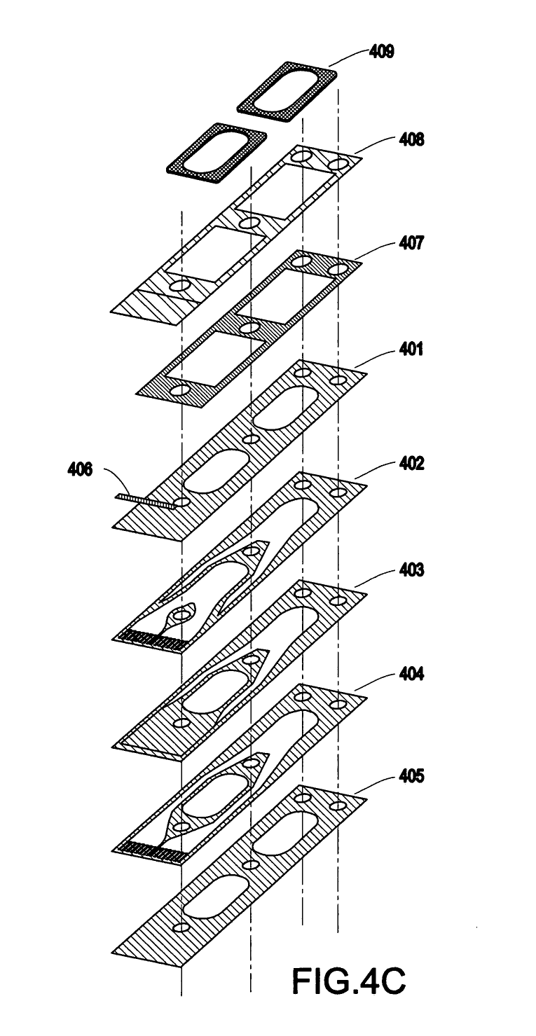

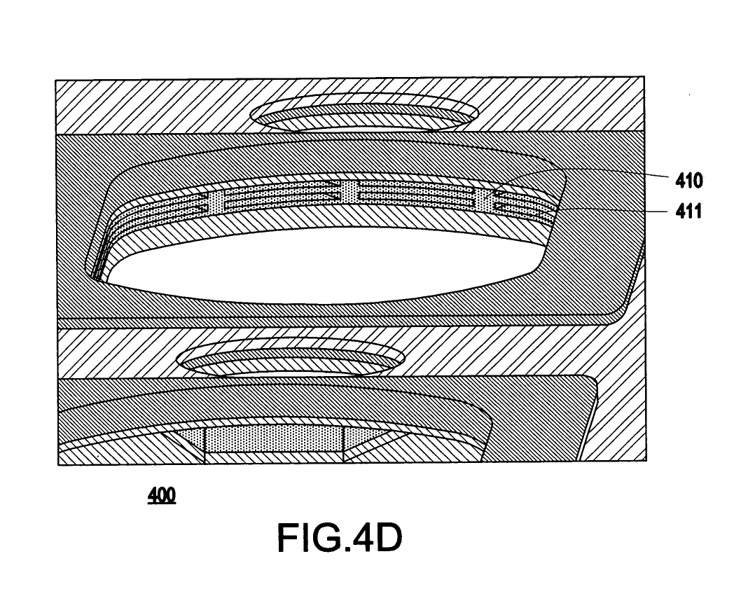

FIGS. 1A-C show an exemplary design of a 12 kW array module, which includes at least one array as shown in FIG. 1A. The array module includes a housing around the array (or stack of diode laser bars). The array in FIG. 1A includes a buna-n (or Viton, EPDM) material 101, which functions as a water seal or gasket for this array (also note the same as FIG. 4C, numeral 409), a stainless steel (or inert plastic; the material must provide suitable corrosion resistance and rigidity) part 102, which functions as a mechanical structure for supporting the array as an interface with the array module housing (depicted in FIG. 1C), a vespel isolator 103, which provides electrical isolation between the array and the array module housing, between the array module housing and the array, a copper block 104 designed in a way which functions as an electrode and water connector to the heatsinks, and a heatsink package 105, which is also depicted in FIGS. 4A-C.

The array module also includes a backbone structure 106 for the array for support, which is machined from acetal copolymer. A kapton tube 107, which slides over a stainless steel rod, holds the array together.

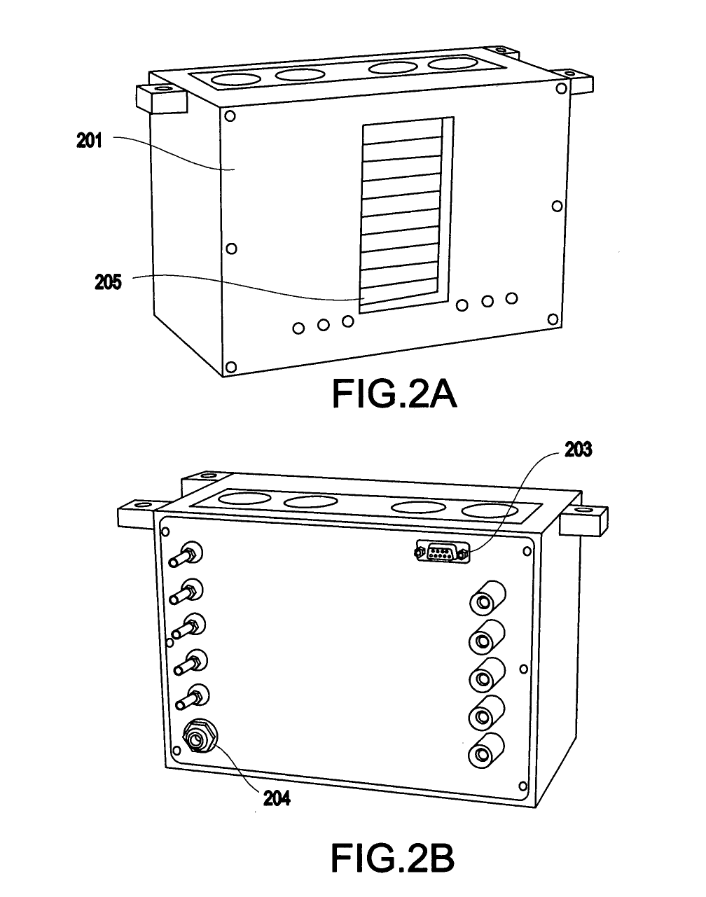

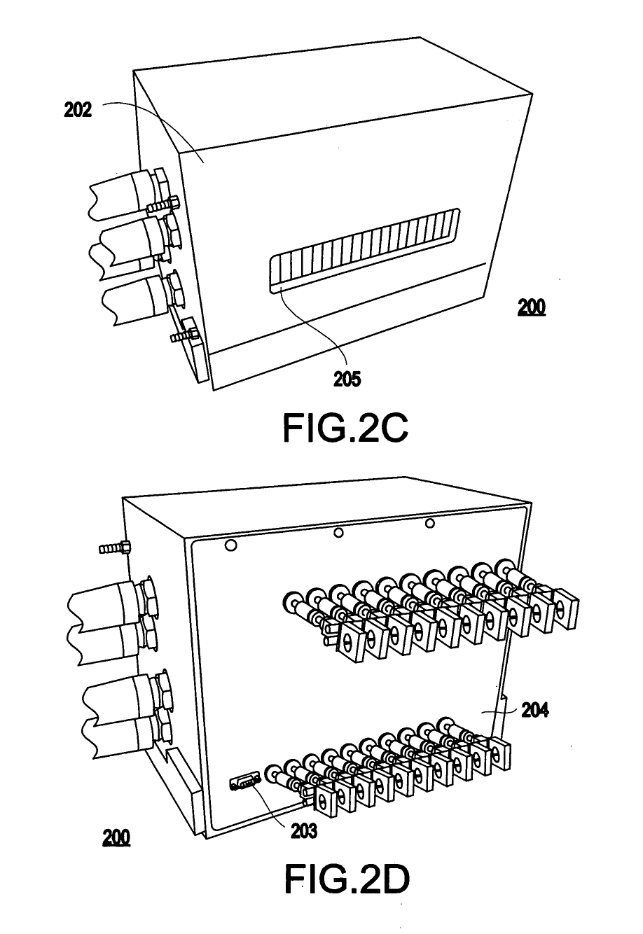

FIGS. 2A-D show the finished manufactured array modules 200. As illustrated, a water-cooled black chrome front nose plate 201, functions as the face of the array module. Additionally, a water-cooled nose plate 202 with reflective gold plating, also functions as the face of the array, providing an enclosure for the arrays. According the exemplary embodiments depicted in FIGS. 2A-2D, the device includes a monitoring control sensor 203 for the purge port 204. Additionally, a front antireflective window 205 provides added protection for the individual diode bars.

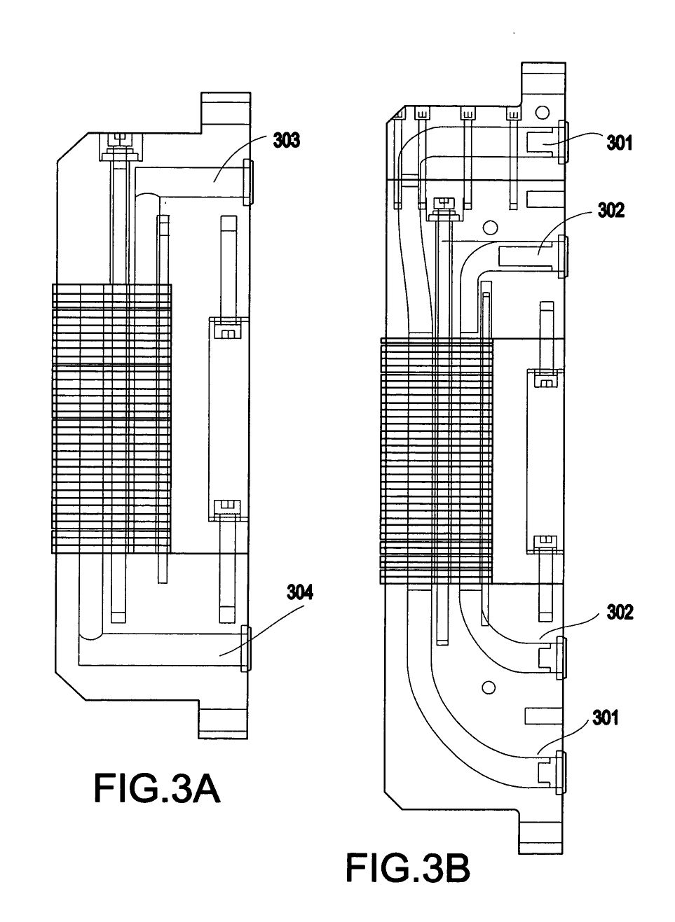

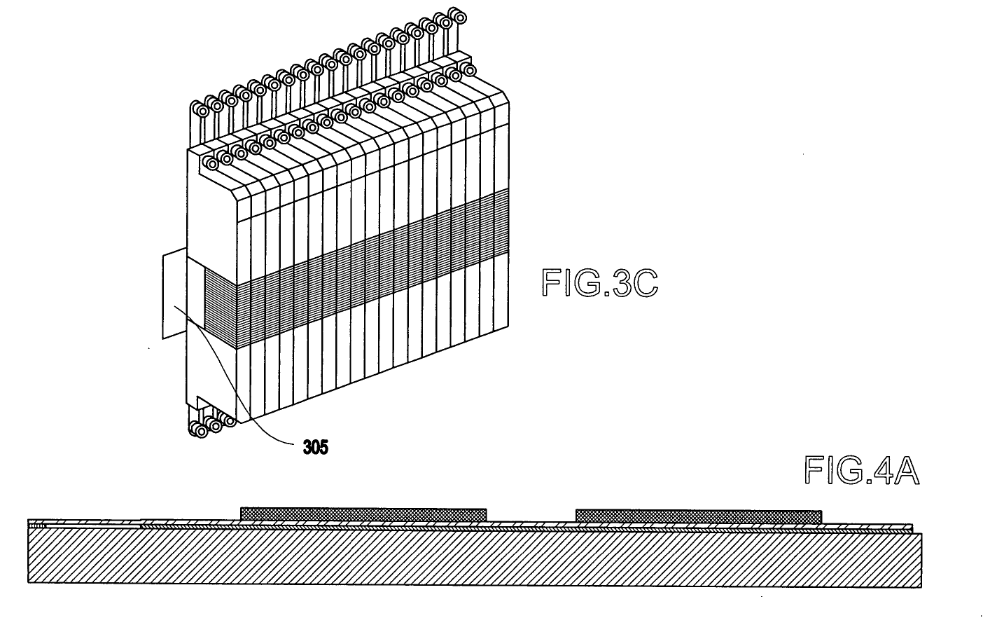

FIGS. 3A-C show the inner designs and workings for fluid flow inside the individual arrays. A water input 301 for these arrays is delivered to the inner workings of the heatsink. The arrays include return lines 302 of the water return to the chiller (which includes the water input 301 and the return lines 302). FIG. 3A illustrates the input 303 for cooling the diode bar and a return line 304. Of unique interest and importance are the manufacturing steps to make the device depicted in FIG. 3B verses the device depicted in FIG. 3A.

The conventional methods, exemplarily depicted in FIG. 3A, cross drill holes. Using the design illustrated in FIG. 3B, however, provides the same amount of fluid flow while reducing the pressure. Specifically, the pressure using the design of FIG. 3B is reduced by approximately 15 psi. Thus, for pressure sensitive system or array designs, the design of the present invention provides a significant advantage over the conventional design.

The end cap (or top and bottom of the array) of the present invention provides improved fluid flow characteristics (e.g., for 34 packages, 27% more fluid flow at the same pressure) because the smooth bend (e.g., as depicted in FIG. 3B) is an improvement over the conventional cross drilling method. That is, right angle turns (or any sharp turn) create fluid drag, which increases pressure drop and reduces flow rate. The water channels in FIG. 3A are at angles of at least 90 degrees. The water channels depicted in 3B, however, are smooth transition turns.

The device of FIG. 3A can be machined according to conventional techniques, with standard machining capabilities. However, the device of FIG. 3B is manufactured by machining the three plates, diffusion-bonding, soldering, or brazing the plates together, then post-machining the plates into the final form that functions as the array end caps. The three plates is a manufacturing step to produce the array ends caps depicted in FIGS. 3A and 3B. The plates are machined, then diffusion bonded, and then post machined to form the smooth bend features. This is important and novel due to the fact that this reduces the pressure drop across the array.

An anti-reflective window 25 keeps unwanted light out of the array module. The antireflective (di-chroic) window 25 provides two purposes. First, the solid state pump material produces laser light of a different wavelength, and the anti-reflective window 25 allows light from the diode laser stack to exit the housing while blocking light generated from the solid state pump material. The light from the pump material can be damaging to the diode laser stack. Second, the window provides mechanical and environmental protection to the fragile diode laser bars inside the housing.

FIGS. 4A-C shows the inner workings of a heat sink 400 according to an exemplary embodiment of the present invention. A GaAs laser diode bar is mounted to a copper layer 401. FIGS. 4A-4C also illustrate the inside of the input layer 402 of the heatsink. A transition layer 403 is disposed between the input and the return. The heatsink also includes a return line 404. Reference 405 indicates the bottom layer of the copper heatsink.

The heatsink may include an insulating layer 407. Additionally, the heatsink may include a top contact or lid 408. The heat sink also includes a buna-n gasket 409. Typically, conventional designs use o-rings. The advantage of using a gasket 409 is that the gasket can be cut into any two-dimensional shape, not just a circle as with an o-ring. Furthermore, when using o-rings, it is not possible to obtain a stack of the desired height without having leaks.

The heat sink is also the Micro Channel Cooled Package (MCCP). Generally, the heat sink package or MCCP is the building block for the laser diode array stacks. These stacks are multiple MCCPs stacked on top of each other while the ends caps are placed on the top and bottom of the stacks. This structure yields one array (e.g., see FIG. 3B). The array module is the housing configuration of one or more arrays (e.g., see FIG. 2C).

In accordance with an exemplary embodiment of the present invention, the input layer 402 and the transition layer 403 of the heat sink may be replaced with half etched layers 410, 411. This provides a heatsink with eight input ports and two return ports.

The water cooled diode laser stacks must operate in a regime such that the dewpoint temperature in the ambient air around the stack does not rise above the temperature of the cooling water, otherwise, the laser will be destroyed. These sensing devices provide a means to monitor and perhaps control the environmental conditions to prevent the destruction of the stack. The module behind the stack is also necessary protect the internals of the housing from either opposing diode laser pump modules or back reflections of diode laser light.

While the invention has been described in terms of several exemplary embodiments, those skilled in the art will recognize that the invention can be practiced with modification within the spirit and scope of the appended claims.

Further, it is noted that, Applicants' intent is to encompass equivalents of all claim elements, even if amended later during prosecution.

What is claimed is:

1. A method of manufacturing high power laser arrays, comprising:
stacking laser diode packages in one array.

2. A method of manufacturing a heatsink that provides the ability to build high power laser arrays, comprising:
using gaskets in two-dimensional array packages; and
configuring a water flow that allows the heat to be dissipated in a two-dimensional stack, said configuring water flow is based on at least one of directional characteristics, physical properties, and fluid routing for relief of pressure restrictions.

3. A high power laser array comprising:
an end cap that allows a smooth transition for fluid flow,
wherein said end cap provides characteristics for fluid flow requirements regarding the pressure drop of the array.

4. A high power diode array module, comprising:
a housing assembly comprising:
a reflective or abortive water-cooled front;
a reflective window disposed behind arrays of the array module; and
a purge and temperature humidity sensor,
wherein the arrays of the array module are enclosed in a controlled environment for high power laser applications.

5. A heat sink, comprising:
a water flow configured to allow heat to be dissipated in a two-dimensional stack.

6. The heat sink according to claim 5, further comprising:
a laser diode bar having a gasket formed therein.

7. A laser diode array, comprising:
at least one laser diode bar, said laser diode bar comprising a water flow configured to allow heat to be dissipated in a two-dimensional stack.

8. The laser diode array according to claim 7, wherein said at least one laser diode bar comprises a plurality of laser diode bars formed in a stack.

9. The laser diode array according to claim 8, further comprising a gasket formed between each of said plurality of laser diode bars.

10. The laser diode array according to claim 7, wherein said at least one laser diode bar comprises a gasket formed thereon.

11. The laser diode array according to claim 7, wherein said at least one laser diode bar is formed in a two-dimensional stack.

12. The laser diode array according to claim 11, further comprising an end cap formed on at least one of a top of said two-dimensional stack and a bottom of said two-dimensional stack.

13. The laser diode array according to claim 12, wherein said end cap comprises a structure having smooth bends.

14. A laser diode array module, comprising:
at least one laser diode bar, said laser diode bar comprising a water flow configured to allow heat to be dissipated in a two-dimensional stack.

15. The laser diode array module according to claim 14, wherein said at least one laser diode bar comprises a plurality of laser diode bars formed in a stack.

16. The laser diode array module according to claim 15, further comprising a gasket formed between each of said plurality of laser diode bars.

17. The laser diode array module according to claim 14, wherein said at least one laser diode bar comprises a gasket formed thereon.

18. The laser diode array module according to claim 14, wherein said at least one laser diode bar is formed in a two-dimensional stack.

19. The laser diode array module according to claim 18, further comprising an end cap formed on at least one of a top of said two-dimensional stack and a bottom of said two-dimensional stack.

20. The laser diode array module according to claim 19, wherein said end cap comprises a structure having smooth bends.
